(19) United States
(12) Patent Application Publication
(10) Pub. No.: US 2008/0252401 A1
(43) Pub. Date: Oct. 16, 2008

(54) Evanescent Mode Resonator Including Tunable Capacitive Post

(75) Inventors: Alexandros Margomenos, Ann Arbor, MI (US); Linda P.B. Katehi, Zionsville, IN (US)

Correspondence Address: MILLER IP GROUP, PLC;EMAG TECHNOLOGIES, INC., 42690 WOODWARD AVE., SUITE 200, BLOOMFIELD HILLS, MI, 48304, US

(73) Assignee: EMAG Technologies, Inc., Ann Arbor, MI (US)

(21) Appl. No.: 11/735,269

(22) Filed: Apr. 13, 2007

(51) Int. Cl. H01P 1/219

(52) U.S. Cl. 333/210

(57) ABSTRACT

An evanescent mode resonator including a cavity formed in a substrate of semiconductor material. The resonator includes a capacitive post positioned within the cavity, and a tuning element positioned within the wall of the cavity proximate to the capacitive post, where a gap between the flexible element and the post sets the tuning of the resonator.

### BACKGROUND OF THE INVENTION

1. Field of the Invention

This invention relates generally to an evanescent mode resonator and, more particularly, to an evanescent mode resonator that employs a tunable capacitive post.

2. Discussion of the Related Art

Evanescent mode resonators that have a high-Q and low-loss characteristics are known in the art for various applications, such as for filtering RF signals at a receiver front end. A few resonators can be cascaded together to provide an RF filter. One known evanescent mode resonator is micro-machined in silicon, and includes a capacitive post positioned within a cavity in which the RF waves resonate. The size of the cavity, the size of the post and a gap between the post and the cavity wall set the resonant frequency and the quality factor (Q) of the resonator. The capacitive post lowers the resonant frequency of the cavity, which allows an RF signal of a certain frequency to resonate within an otherwise much smaller cavity to provide a relatively small filter structure for lower frequencies.

Known evanescent mode filters are permanently tuned to a particular wavelength, and thus, only operate at that frequency. It would be desirable to selectively tune an evanescent mode filter so that it resonated at different frequencies over a relatively large frequency band.

Further, known evanescent mode filters are generally based on waveguide components, and are therefore, difficult to integrate with other millimeter wave integrated circuits.

### SUMMARY OF THE INVENTION

In accordance with the teachings of the present invention, an evanescent mode resonator is disclosed that includes a cavity formed within a semiconductor substrate, such as silicon. A capacitive post is provided within the cavity. An RF signal is introduced into the cavity, which resonates therein, and is output from the cavity having a narrow frequency band. A flexible element is positioned within a wall of the cavity proximate to the capacitive post, where the flexible element is electrically moved relative to the post to change the gap between the flexible element and the post, and tune the frequency of the cavity.

Additional features of the present invention will become apparent from the following description and appended claims, taken in conjunction with the accompanying drawings.

### BRIEF DESCRIPTION OF THE DRAWINGS

FIG. 1 is a blown-apart perspective view of a tunable evanescent mode filter, according to an embodiment of the present invention;

FIG. 2 is a schematic diagram of an equivalent circuit of an evanescent mode resonator; and

FIGS. 3(a)-3(m) are cross-sectional views of various semiconductor layers showing processing steps for fabricating an evanescent mode resonator, according to an embodiment of the present invention.

### DETAILED DESCRIPTION OF THE EMBODIMENTS

The following discussion of the embodiments of the invention directed to a tunable evanescent mode resonator and method for making same is merely exemplary in nature, and is in no way intended to limit the invention or its applications or uses.

FIG. 1 is a blown-apart perspective view of an evanescent mode filter 10, according to an embodiment of the present invention. The filter 10 may have application for frequencies of GHz and above. The filter 10 includes a relatively thick base substrate layer 12 having a cavity 14 formed therein. Any suitable semiconductor micro-machining process can form the cavity 14. A series of capacitive posts 16 are provided within the cavity 14 to tune the filter 10 to the desired frequency in a manner that is well understood to those skilled in the art. Although the capacitive posts 16 are show here as being square, the invention contemplates any shape post suitable for an evanescent mode filter, including, but not limited to, square, rectangular, round, misshapen, etc. A metallized layer 18, such as gold, is deposited within the cavity 14 and on the post 16 to cause the RF waves to reflect within the cavity 14. The filter 10 includes a semiconductor top cover 20 that provides a top surface of the cavity 14, and includes an underside metallized layer.

The substrate layer 12 and the cover 20 are micro-machined from a semiconductor material, such as silicon. By fabricating the filter 10 from a semiconductor material, the filter 10 can be integrated on a common semiconductor wafer with other semiconductor devices.

A metallized input connector 28 is formed on a top surface 30 of the cover 20. An input coplanar waveguide 32 is patterned on the top surface 30 of the cover 20 and is impedance matched to the connector 28. Likewise, a metallized output connector 34 is formed on the top surface 30 opposite to the input connector 28. An output coplanar waveguide 36 is patterned on the top surface 30 relative to the output connector 34, and is impedance matched thereto.

A slot 38 is provided through the metallized layer on the bottom surface of the cover 20 relative to the coplanar waveguide 32, and a slot 40 is provided through the metallized layer on the bottom surface of the cover 20 relative to the coplanar waveguide 36. An RF signal coupled to the connector 28 propagates down the waveguide 32 through the slot 38 and into the cavity 14. A controlled gap is provided between the capacitive post 16 and the metallized layer on the bottom surface of the cover 20. The gap defines the frequency tuning of the filter 10, where the combination of the three capacitive posts 16 provides the filter. The tuned RF output signal propagates through the slot 40 down the waveguide 36 and is output by the output connector 34.

As mentioned above, the gap between the metallized undersurface of the cover 20 and the capacitive posts 16 define the frequency tuning of the filter 10. According to the invention, flexible elements 50 are provided in the cover 20 relative to the capacitive posts 16, and are movable to increase or decrease the gap therebetween. In one non-limiting embodiment, the flexible elements 50 are piezoelectric transducers that receive a DC bias signal on lines 52 that control their flexure. In an alternate embodiment, the flexible elements 50 are thermal elements that expand when they are heated. In another embodiment, the flexible elements 50 are static elements that flex in response to an electrostatic field. It has been shown that each flexible element 50 can change the tuning of the filter 20 in the range of 10-15 GHz.

The evanescent mode filter 10 is a filter because of the plurality of capacitive post 16 provided in the cavity 14. If a single capacitive post 16 were provided in the cavity 14, then the filter 10 would be a resonator. In an alternate embodiment, a plurality of evanescent mode resonators can be cascaded together where the connector 34 is coupled to an input connector of a next resonator in the cascaded series.

Many applications require an RF signal to be filtered. In one embodiment, the connector 28 is electrically coupled to an input antenna, and the output connector 34 is electrically coupled to an RF front end of a receiver. Therefore, the signals that are received by the antenna are filtered to pass only the desired RF wavelength.

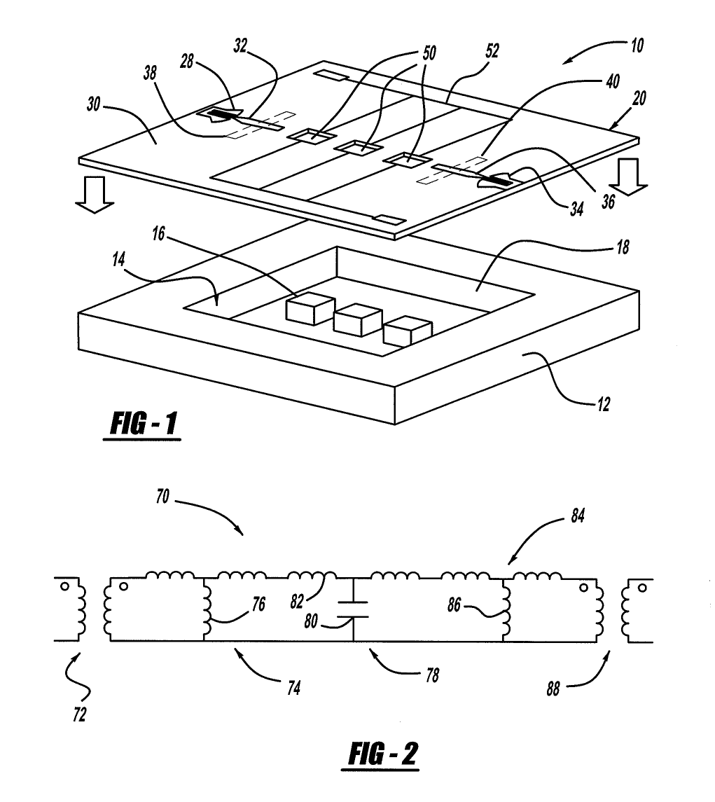

FIG. 2 is a schematic diagram of an equivalent circuit 70 of an evanescent mode resonator. An RF input signal is provided to an input coupling transformer 72. The transformed input signal propagates through a first evanescent inductive section 74 including an inductive T-circuit made up of inductors 76. The signal from the first evanescent inductive section 74 then propagates through a filtering section 78 including a capacitor 80, representing the capacitive posts 16, and inductors 82. The filtered RF signal from the filtering section 78 is then sent to a second evanescent inductive section 84 including a T-circuit made up of inductors 86. The filter signal is then output through an output transformer 88.

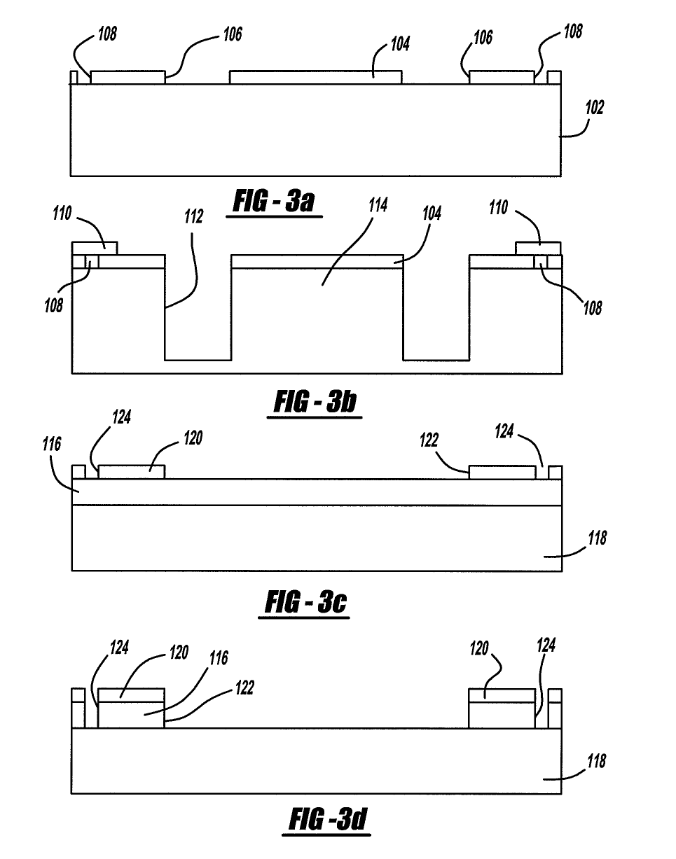

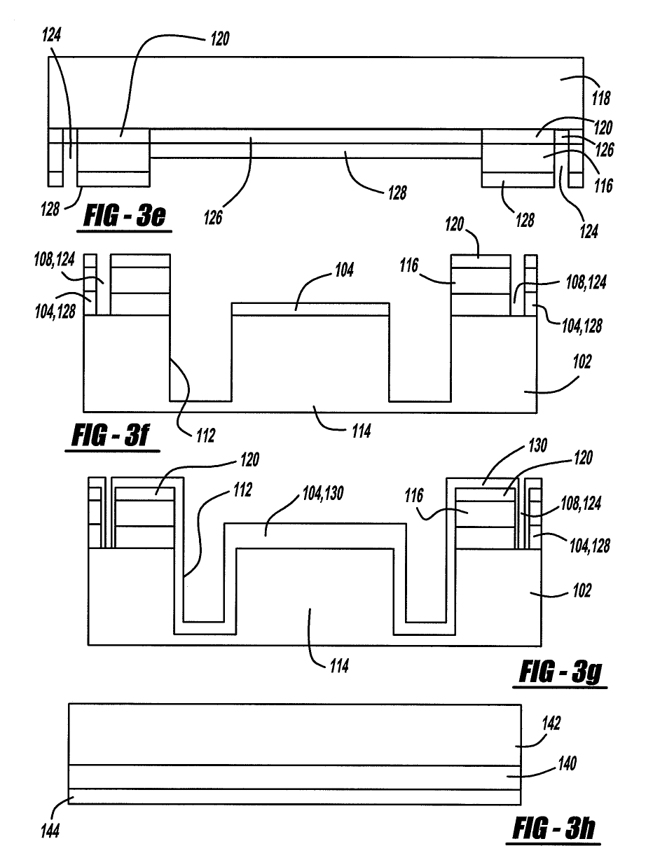

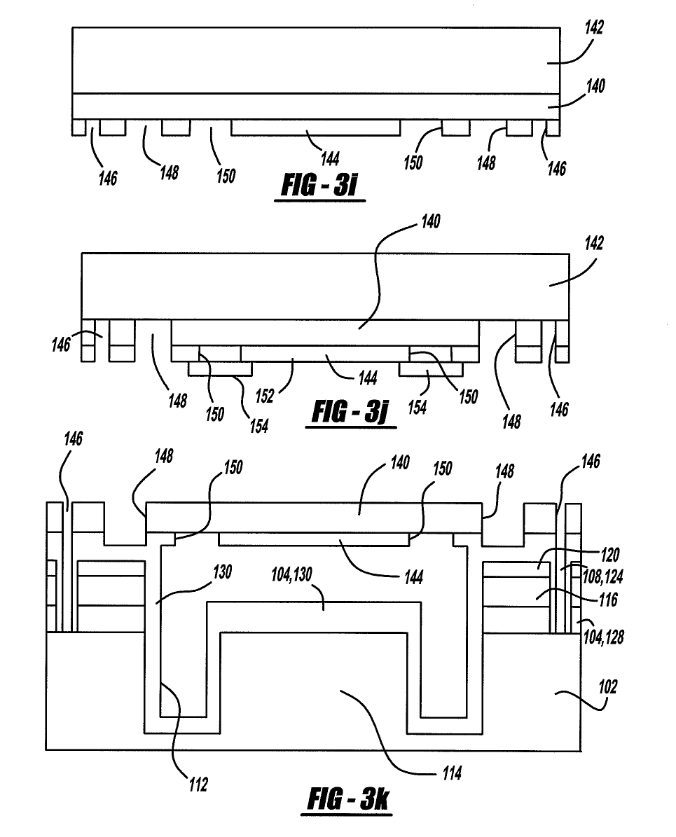

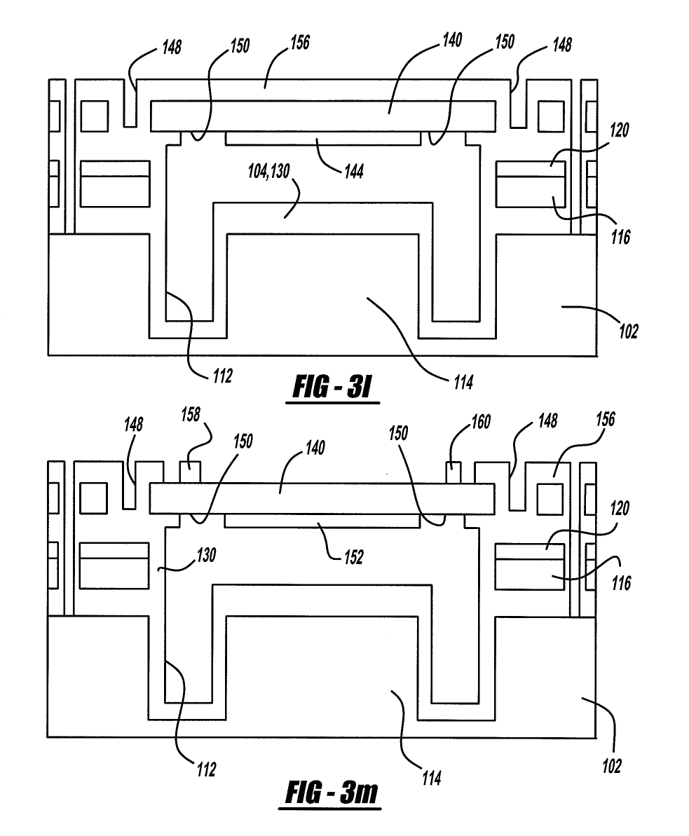

FIGS. 3(a)-3(m) are cross-sectional views of various semiconductor layers showing processing steps for fabricating an evanescent mode resonator, according to an embodiment of the present invention. As discussed above, the evanescent mode resonator is micro-machined in silicon, or another suitable semiconductor wafer, such GaAs, InP, etc., so that it can be effectively integrated with other semiconductor devices. As will be appreciated by those skilled in the art, various other semiconductor fabrication steps can also be performed to provide an evanescent mode resonator of the invention.

FIG. 3(a) shows a semiconductor wafer 102 that has been micro-machined to about 500 μm thick. A conductive layer 104, such as Cr/Au, is deposited, for example by sputtering, on the semiconductor substrate 102, and is patterned using a suitable mask (not shown) to define openings 106 and alignment marks (holes) 108.

FIG. 3(b) shows covering the alignment marks 108 with a patterned mask 110, and performing a deep reactive ion etch (DRIE) into the substrate 102 through the openings 106 to provide a recess 112 that defines the cavity, where the remaining portion 114 will be a capacitive post. In one embodiment, the recess 112 is about 450 μm deep, leaving a 50 μm thickness at the bottom of the substrate 102.

FIG. 3(c) shows a spacer wafer 116, such as a silicon wafer, mounted to a handling wafer 118. In one non-limiting embodiment, the spacer wafer 116 is about 100 μm thick. A conductive layer 120, such as Cr/Au, is deposited, for example by sputtering, on the wafer 116, and is patterned using a suitable mask (not shown) to define an opening 122 that will align with the recess 112 and alignment marks (holes) 124 that will align with the alignment marks 108.

FIG. 3(d) shows a DRIE has been performed through the opening 122 and the alignment marks 124 all of the way through the spacer wafer 116.

FIG. 3(e) shows that the handling wafer 118 has been removed from one side of the wafer 116 and mounted to the other side of the wafer 116. A photoresist layer 126 is patterned and deposited within the opening 122 and the alignment marks 124 on the wafer 116, and a conductive layer 128 is then deposited, such as by sputtering, on the photoresist layer 122.

FIG. 3(f) shows that the handling wafer 118 has been removed from the spacer wafer 116, and the spacer wafer 116 has been mounted to the substrate 102 using the conductive layers 104 and 128, where the alignment marks 108 and 124 are aligned. Any suitable fabrication technique can be used to cause the conductive layers 104 and 128 to form together.

FIG. 3(g) shows a conductive layer 130, such as Au, is deposited, such as by sputtering, over the entire combination of the substrate 102 and the spacer layer 116.

FIG. 3(h) shows a semiconductor wafer 140, such as silicon, attached to a handling wafer 142, where a side of the wafer 140 opposite to the handling wafer 142 is coated with a conductive layer 144, such as gold, by, for example, sputtering. The wafer 140 will be the cover of the resonator.

FIG. 3(i) shows that the conductive layer 144 has been patterned and etched to provide alignment marks 146, slots 150 so that RF energy can get into and out of the cavity and windows 148 for visually inspecting the wafer fabrication.

FIG. 3(j) shows a DRIE has been performed into the wafer 140 at the alignment marks 146 and the windows 148, where the slots 150 have been covered with a photoresist 154 so that they are not etched.

The handling wafer 142 is removed from the wafer 140, and the wafers 102, 116 and 140 are all bonded together using the various conductive layers, as shown in FIG. 3(k).

FIG. 3(l) shows a blanket deposit of a conductive layer 156, such as gold, by, for example, sputtering, on the wafers 102, 116 and 140.

FIG. 3(m) shows an etch has been performed through the conductive layer 156 to create the input and output lines 158 and 160, and window metallization to provide the resonator.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. An evanescent mode resonator comprising:
a substrate including a cavity having a conductive layer;
at least one capacitive post positioned within the cavity;
a cover layer covering the cavity; and
at least one flexible element positioned within the cover layer relative to the at least one capacitive post and defining a gap therebetween, wherein an RF signal sent into the cavity resonates therein at a frequency determined by the size of the cavity, the size of the capacitive post and the width of the gap, and wherein the at least one flexible element is movable to change the width of the gap and tune the resonator to different frequencies.

2. The resonator according to claim 1 wherein the at least one flexible element is a piezoelectric element.

3. The resonator according to claim 1 wherein the at least one flexible element is a thermal element that contracts and expands in response to heat.

4. The resonator according to claim 1 wherein the at least one flexible element is an electrostatic element that contracts and expands in response to an electrical charge.

5. The resonator according to claim 1 wherein the substrate is a semiconductor substrate and the cover layer is a semiconductor cover layer.

6. The resonator according to claim 5 wherein the substrate is a silicon substrate and the cover layer is a silicon cover layer.

7. The resonator according to claim 1 wherein the conductive layer is a chromium/gold layer.

8. The resonator according to claim 1 wherein the at least one capacitive post is a plurality of capacitive posts and the at least one flexible element is a plurality of flexible elements to control all of the gap distances.

9. The resonator according to claim 1 further comprising an input co-planar waveguide and an output co-planar waveguide fabricated on a surface of the cover layer opposite to the cavity.

10. The resonator according to claim 1 further comprising an input slot formed through a conductive layer on a surface of the cover layer facing the cavity and an outlet slot formed through the conductive layer on the surface of the cover layer facing the cavity, wherein an input RF signal on the input co-planar waveguide is input into the cavity through the input slot and an output RF signal is output from the cavity through the output slot to be propagated along the output co-planar waveguide.

11. The resonator according to claim 1 wherein the substrate has a thickness of about 500 μm.

12. An evanescent mode resonator comprising:
a silicon substrate including a cavity formed therein, said cavity including a conductive layer;
at least one capacitive post positioned within the cavity, said capacitive post also including a conductive layer;
a silicon cover layer covering the cavity;
at least one flexible element positioned within the cover layer relative to the at least one capacitive post and defining a gap therebetween;
an input co-planar waveguide fabricated on a surface of the cover layer opposite to the cavity; and
an output co-planar waveguide fabricated on the surface of the cover layer opposite to the cavity, wherein an RF signal is applied to the input co-planar waveguide and sent into the cavity and an output RF signal from the cavity is received by the output co-planar waveguide, and wherein the RF signal resonates within the cavity a frequency determined by the size of the cavity, the size of the capacitive post and the width of the gap, and wherein the at least one flexible element is movable to change the width of the gap to tune the resonator to different frequencies.

13. The resonator according to claim 12 wherein the at least one flexible element is a piezoelectric element.

14. The resonator according to claim 12 wherein the at least one flexible element is a thermal element that contracts and expands in response to heat.

15. The resonator according to claim 12 wherein the at least one flexible element is an electrostatic element that contracts and expands in response to an electrical charge.

16. The resonator according to claim 12 wherein the at least one capacitive post is a plurality of capacitive posts and the at least one flexible element is a plurality of flexible elements to control all of the gap distances.

17. The resonator according to claim 12 further comprising an input slot formed through a conductive layer on a surface of the cover layer facing the cavity and an outlet slot formed through the conductive layer on the surface of the cover layer facing the cavity, wherein an input RF signal on the input co-planar waveguide is input into the cavity through the input slot and an output RF signal is output from the cavity through the output slot to be propagated along the output co-planar waveguide.

18. The resonator according to claim 12 wherein the substrate has a thickness of about 500 μm.

19. An evanescent mode resonator comprising:
a resonating cavity formed in a semiconductor material;
a capacitive element positioned within the cavity; and
a tuning element positioned relative to the capacitive post for tuning the resonator to different frequencies.

20. The resonator according to claim 19 wherein the semiconductor material is silicon.
